(19) United States
(12) Patent Application Publication
(10) Pub. No.: US 2025/0305911 A1
(43) Pub. Date: Oct. 2, 2025

(54) NV LEVEL DETERMINATION SYSTEM AND NV LEVEL DETERMINATION METHOD

(71) Applicant: HONDA MOTOR CO., LTD., Tokyo (JP)

(72) Inventor: Norimasa Shudo, Wako-shi (JP)

(21) Appl. No.: 19/051,630

(22) Filed: Feb. 12, 2025

(30) Foreign Application Priority Data
Mar. 28, 2024 (JP) 2024-054099

(51) Int. Cl. G01M 13/028; G01M 13/021

(52) U.S. Cl. CPC G01M 13/028; G01M 13/021

(57) ABSTRACT

An NV level determination system determines a noise vibration (NV) level that is a level of noise or vibration occurring from a power transmission unit of an electric vehicle, and includes: a rotor rotation angle recognition section that recognizes an angle of rotation of a rotor of a drive motor; a transmission error recognition section that recognizes a transmission error in the power transmission unit, based on a change degree of an amount of change in angle of rotation of the rotor with respect to an amount of change in angle of rotation of a driveshaft of the electric vehicle in a state where external force to rotate the driveshaft at a predetermined rotation speed is applied to the driveshaft; and an NV level determination section that determines the NV level, based on the transmission error recognized by the transmission error recognition section.

### INCORPORATION BY REFERENCE

The present application claims priority under 35 U.S.C. § 119 to Japanese Patent Application No. 2024-054099 filed on Mar. 28, 2024. The content of the application is incorporated herein by reference in its entirety.

### BACKGROUND OF THE INVENTION

### Field of the Invention

The present invention relates to an NV level determination system and an NV level determination method that determine a level of NV (Noise Vibration) generated in a power transmission unit mounted on a vehicle.

### Description of the Related Art

Conventionally, a vibration test apparatus has been proposed in which a speed reducer for a vehicle is solely fixed to a support base of the test apparatus and a vibration sensor is attached to the speed reducer, and that evaluates vibrations occurring in the speed reducer by receiving a signal from the vibration sensor in a state where torque is applied to the speed reducer (for example, see Japanese Patent Laid-Open No. 2012-132862).

In the vibration test apparatus according to the related art, in order to evaluate vibrations associated with the speed reducer that is dismounted from the vehicle, it is necessary to prepare a facility for fixing the speed reducer and applying torque, and it is necessary to prepare a measurement device that processes the signal from the vibration sensor.

The present invention has been made in view of such background, and an object thereof is to provide an NV level determination system and an NV level determination method that make it possible, with a simple configuration, to determine a level of NV (Noise Vibration) generated in a power transmission unit mounted on a vehicle.

### SUMMARY OF THE INVENTION

A first aspect to achieve the object is an NV level determination system that determines a noise vibration (NV) level for an electric vehicle including a drive motor and a power transmission unit that transmits driving force of the drive motor to a wheel, the NV level being a level of noise or vibration occurring from the power transmission unit, the NV level determination system including: a rotor rotation angle recognition section that recognizes an angle of rotation of a rotor of the drive motor; a transmission error recognition section that recognizes a transmission error in the power transmission unit, based on a change degree of an amount of change in angle of rotation of the rotor with respect to an amount of change in angle of rotation of a driveshaft of the electric vehicle in a state where external force to rotate the driveshaft at a predetermined rotation speed is applied to the driveshaft; and an NV level determination section that determines the NV level, based on the transmission error recognized by the transmission error recognition section.

In the NV level determination system, the predetermined rotation speed may be configured to be set within a rotation speed range including a rotation speed corresponding to a travel speed, in an assumed travel speed range of the electric vehicle, at which the NV level is assumed to become highest.

In the NV level determination system, the predetermined rotation speed may be configured to be set for each vehicle type of electric vehicle.

A second aspect to achieve the object is an NV level determination method of determining a noise vibration (NV) level for an electric vehicle including a drive motor and a power transmission unit that transmits driving force of the drive motor to a wheel, the NV level being a level of noise or vibration occurring from the power transmission unit, the NV level determination method including: a rotor rotation angle recognition step of recognizing an angle of rotation of a rotor of the drive motor; a transmission error recognition step of recognizing a transmission error at a gear included in the power transmission unit, based on a change degree of an amount of change in angle of rotation of the rotor with respect to an amount of change in angle of rotation of a driveshaft of the electric vehicle in a state where external force to rotate the driveshaft at a predetermined rotation speed is applied to the driveshaft; and a gear NV level determination step of determining the NV level, based on the transmission error recognized in the transmission error recognition step.

According to the NV level determination system and the NV level determination method, it is possible, with a simple configuration, to determine a level of NV (Noise Vibration) generated in a power transmission unit mounted on a vehicle.

### BRIEF DESCRIPTION OF THE DRAWINGS

FIG. 1 is an explanatory diagram of a configuration of an NV level determination system;

FIG. 2 is an explanatory diagram in which an NV level of a power transmission unit is determined by the NV level determination system;

FIG. 3 is an explanatory diagram of a transmission system that rotates a drive motor by applying external force from a tire-wheel assembly side of the electric vehicle;

FIG. 4 is an explanatory diagram of a procedure for setting a rotation speed of a driveshaft used in determining the NV level; and

FIG. 5 is a flowchart of NV level determination processing.

### DETAILED DESCRIPTION OF THE INVENTION

### 1. Configuration of NV Level Determination System

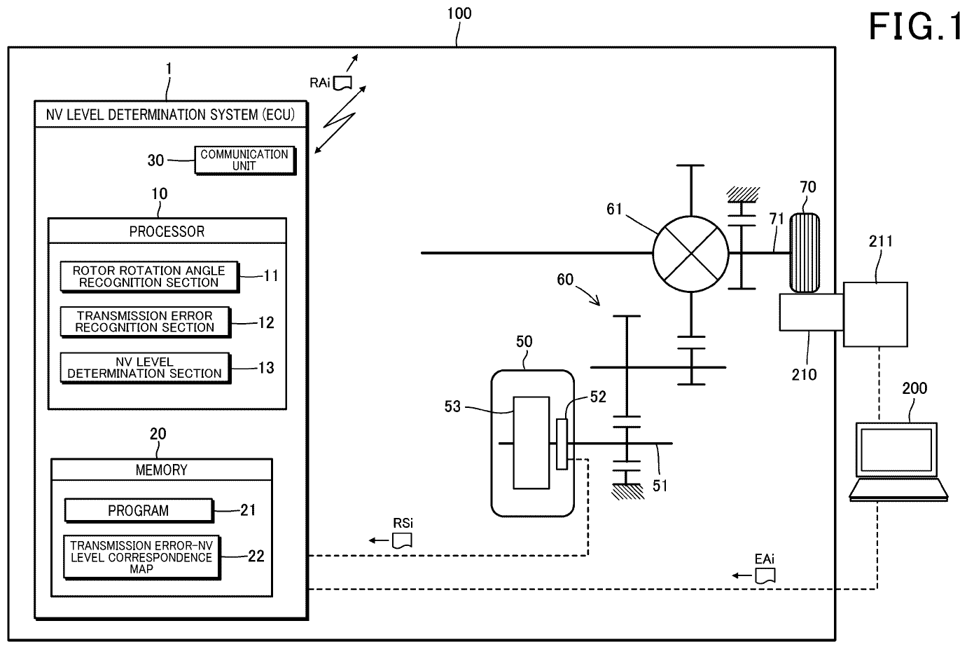

A configuration of an NV level determination system 1 according to an embodiment is described with reference to FIGS. 1 to 4. Referring to FIG. 1, the NV level determination system 1 determines a NV (Noise Vibration) level that is a level of noise or vibration generated in a power transmission unit 60 mounted on an electric vehicle 100.

The electric vehicle 100 is a BEV (Battery Electric Vehicle), an HEV (Hybrid Electric Vehicle), a PHEV (Plug-in Hybrid Electric Vehicle), an FCV (Fuel Cell Vehicle), or the like including a drive motor 50.

The power transmission unit 60 transmits driving force of the drive motor 50 to a tire-wheel assembly 70 coupled to a driveshaft 71. The power transmission unit 60 includes a differential 61, a plurality of gears, and the like. A resolver 52 that detects an angle of rotation of a rotor of the drive motor 50 is installed on a motor shaft 51 of the drive motor 50.

The NV level determination system 1 is configured as part of the functionality of an ECU (Electronic Control Unit) included in the electric vehicle 100, and is connected to the resolver 52. Moreover, when determining an NV level, the NV level determination system 1 is connected to a measurement device 200 and communicates with the measurement device 200. The NV level determination system 1 includes a processor 10, a memory 20, and a communication unit 30 (transmitter/receiver, circuit).

A program 21 for control of the NV level determination system 1 and data on a transmission error-NV level correspondence map 22 are stored in the memory 20. In the transmission error-NV level correspondence map 22, a transmission error in the power transmission unit 60 and an NV level during operation of the power transmission unit 60 are associated. The transmission error-NV level correspondence map 22 will be described later.

The processor 10 functions as a rotor rotation angle recognition section 11, a transmission error recognition section 12, and an NV level determination section 13 by reading and executing the program 21. A process that is executed by the rotor rotation angle recognition section 11 corresponds to a rotor rotation angle recognition step in an NV level determination method of the present disclosure, and a process that is executed by the transmission error recognition section 12 corresponds to a transmission error recognition step in the NV level determination method of the present disclosure. A process that is executed by the NV level determination section 13 corresponds to an NV level determination step in the NV level determination method of the present disclosure.

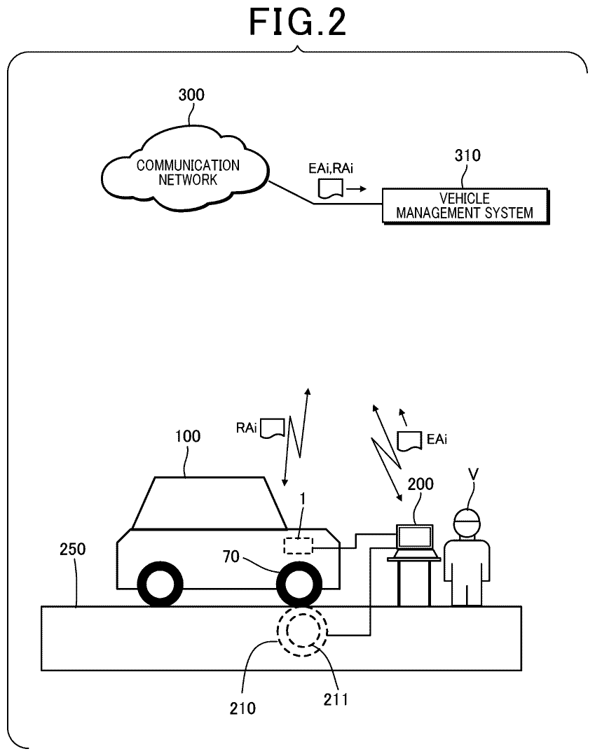

The rotor rotation angle recognition section 11 recognizes an angle of rotation of a rotor 53 of the drive motor 50, based on a rotor angle detection signal RSi outputted from the resolver 52. The transmission error recognition section 12 recognizes a transmission error in the power transmission unit 60 by, as shown in FIG. 2, placing the electric vehicle 100 on a chassis base 250, bringing the tire-wheel assembly 70 of the electric vehicle 100 into contact with a roller 210, and rotating the roller 210 by using a roller motor 211 and thus rotating the tire-wheel assembly 70 with external force.

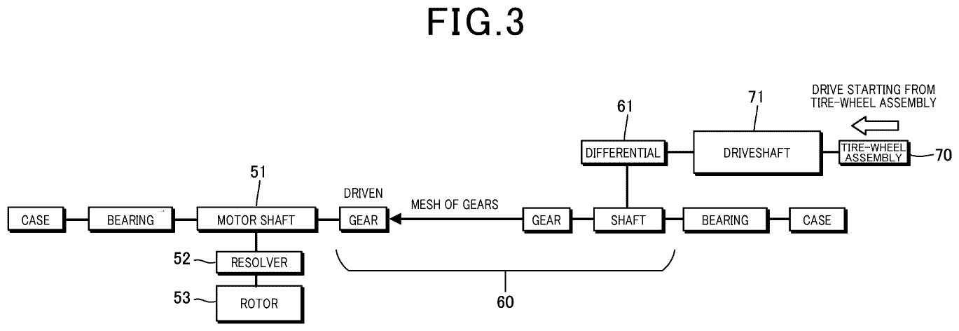

FIG. 3 shows an aspect of power transmission when the tire-wheel assembly 70 is rotated by the roller 210. Driving force applied to the tire-wheel assembly 70 by the roller 210 is transmitted from the driveshaft 71 to the motor shaft 51 of the drive motor 50 on a driven side via the differential and the plurality of gears of the power transmission unit 60, to rotate the rotor 53, and an angle of rotation of the rotor 53 is detected by the resolver 52.

Here, in an ideal state where there is no transmission error in the power transmission unit 60, the ratio of an amount of change Δθr in angle of rotation of the rotor 53 to an amount of change Δθd in angle of rotation of the driveshaft 71 is a constant value according to a gear ratio of the power transmission unit 60. However, in actuality, the angle of rotation of a driven gear increases or decreases relatively to the angle of rotation of a driving gear due to a tooth surface shape error or the like between the gears, and consequently, a transmission error occurs in the power transmission unit 60.

Accordingly, the transmission error recognition section 12 calculates a transmission error (loaded static transmission error) in the power transmission unit 60, by using an expression (1) below, based on the change degree of the amount of change Δθr in angle of rotation of the rotor 53, which is recognized by the rotor rotation angle recognition section 11, with respect to the amount of change Δθd in angle of rotation of the driveshaft 71 (=angle of rotation of the tire-wheel assembly 70) according to a rotation speed in a state where the tire-wheel assembly 70 is rotated by the roller 210 at a predetermined rotation speed:

$$Transmission error = Δθ d - Δθ r \times Zr / Zd \qquad ( 1 )$$

where Δθd is the amount of change in angle of rotation of the driveshaft 71, Δθr is the amount of change in angle of rotation of the rotor 53 recognized by the rotor rotation angle recognition section 11, Zr is the number of driven teeth, and Zd is the number of driving teeth.

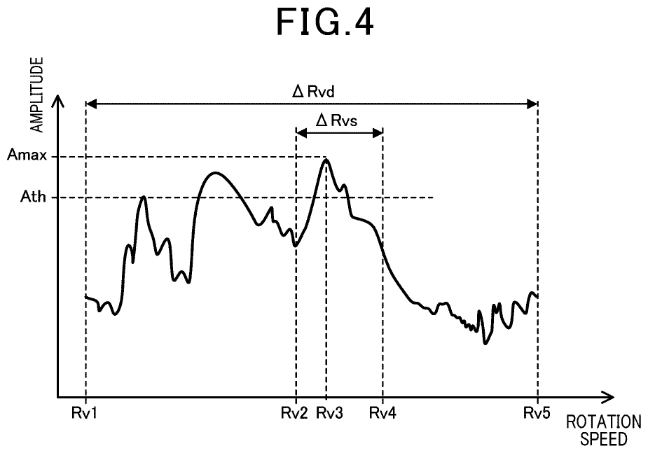

The predetermined rotation speed at which the tire-wheel assembly 70 is rotated by the roller 210 is determined by causing a model vehicle of the same type as the electric vehicle 100 to travel in an assumed speed range and measuring an NV level at each speed, as shown in FIG. 4. FIG. 4 shows measurement values of NV level (amplitude of vibrations or volumes of noise) corresponding to individual rotation speeds, with a vertical axis set for the measurement values of NV level, and a horizontal axis set for the rotation speeds of the driveshaft corresponding to the travel speeds of the model vehicle. ΔRvd is a rotation speed range of the driveshaft corresponding to the assumed speed range of the vehicle.

In FIG. 4, when the rotation speed is Rv3, the NV level is Amax, which is the highest, and it can be estimated that a relatively large NV tends to easily occur at the rotation speed of Rv3. Accordingly, the predetermined rotation speed of the driveshaft used in recognizing a transmission error is set within a rotation speed range ΔRvs including Amax.

The NV level determination section 13 recognizes an NV level of the power transmission unit 60 by applying the transmission error in the power transmission unit 60 recognized by the transmission error recognition section 12, to the transmission error-NV level correspondence map 22 (see FIG. 1). Here, there is a relationship of the following expression (2) between the NV level and the transmission error.

NV level=transmission error×mesh force×vibration transmission characteristic (2)

The mesh force is dynamic excitation force that hits gear tooth surfaces, and the vibration transmission characteristic is a degree of performance owned by an anti-vibration/vibration absorption product (a case or the like), in terms of what vibrations, as a target, can be reduced to what extent.

According to the expression (2), there is such a relationship that the larger the transmission error in the power transmission unit 60 is, the higher the NV level is, and an NV level therefore can be determined based on a result of the recognition of the transmission error. The transmission error-NV level correspondence map 22 is created based on a test on the vehicle type or the specification of the electric vehicle 100, or based on a result of computer simulation.

The NV level determination section 13 compares the recognized NV level of the power transmission unit 60 with a determination threshold value Ath (see FIG. 4) and determines the NV level of the power transmission unit 60, for example, through three-level classification as follows.
A level: recognized NV level≥determination threshold value
B level: determination threshold value<recognized NV level≤upper-limit value
C level: upper-limit value<recognized NV level

In a case of A level, the power transmission unit 60 is reused without taking any countermeasure against NV.

In a case of B level, the power transmission unit 60 is reused after a countermeasure against NV, such as a dynamic damper, is implemented.

In a case of C level, the power transmission unit 60 is disposed of and recycled.

### 2. NV Level Determination Processing

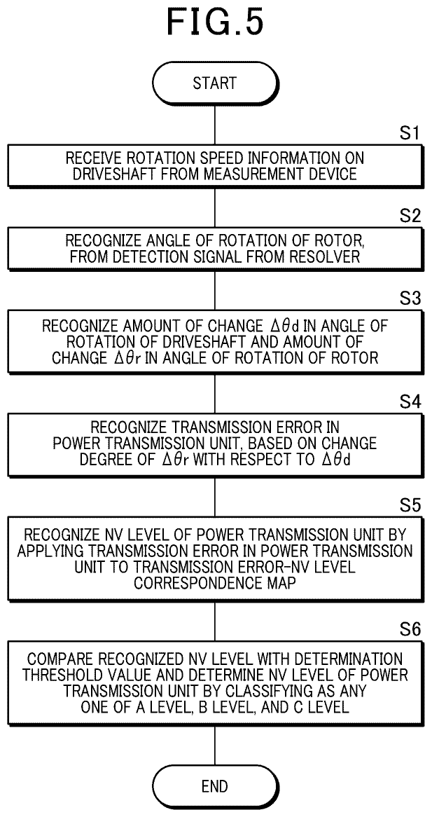

A procedure for NV level determination processing that is performed by the NV level determination system 1 is described by following a flowchart shown in FIG. 5. The NV level determination system 1 performs the processing according to the flowchart shown in FIG. 5 in a state where the electric vehicle 100 is placed on the chassis base 250 and the tire-wheel assembly 70 is rotated by the roller 210 at the predetermined rotation speed as described with reference to FIG. 2.

In step S1 in FIG. 5, the transmission error recognition section 12 acquires, by receiving from the measurement device 200, rotation speed information EAi indicating a rotation speed (predetermined rotation speed) of the driveshaft 71. In subsequent step S2, the rotor rotation angle recognition section 11 recognizes an angle of rotation of the rotor 53 of the drive motor 50, from a rotor angle detection signal RSi from the resolver 52. In subsequent step S3, the transmission error recognition section 12 recognizes an amount of change 40d in the angle of rotation of the driveshaft 71 recognized from the predetermined rotation speed, and an amount of change Δθr in the angle of rotation of the rotor 53 recognized by the rotor rotation angle recognition section 11.

In subsequent step S4, the transmission error recognition section 12 recognizes a transmission error in the power transmission unit 60 from the expression (1), based on the change degree of Δθr with respect to Δθd. In subsequent step S5, the NV level determination section 13 recognizes an NV level of the power transmission unit 60 by applying the transmission error recognized by the transmission error recognition section 12 to the transmission error-NV level correspondence map 22.

In subsequent step S6, the NV level determination section 13 compares the recognized NV level of the power transmission unit 60 with the determination threshold value Ath and determines the NV level of the power transmission unit 60 by classifying the NV level as any one of A level, B level, and C level as described above.

### 3. Other Embodiments

In the embodiment, the driveshaft 71 is rotated by rotating the tire-wheel assembly 70 by using the roller 210, as shown in FIGS. 1 and 2. However, the driveshaft 71 may be rotated by using another scheme to apply external force thereto, such as removing the tire-wheel assembly 70 and coupling rotation means to a hub.

In the embodiment, the NV level determination system of the present disclosure is configured as part of the functionality of the ECU mounted in the electric vehicle 100. However, the NV level determination system of the present disclosure may be configured as a dedicated system mounted in the electric vehicle 100. Alternatively, the NV level determination system of the present disclosure may be configured as a function of a vehicle management system 310 that performs communication with the electric vehicle 100 as shown in FIG. 2. In such a case, the rotation speed information EAi indicating the predetermined rotation speed at which the tire-wheel assembly 70 is rotated is sent from the measurement device 200 to the vehicle management system 310, and rotor rotation angle information RAi indicating an angle of rotation of the rotor 53 is sent from the electric vehicle 100 to the vehicle management system 310. Then, processing of determining an NV level of the power transmission unit 60 is performed by the vehicle management system 310, similarly to the processing according to the flowchart shown in FIG. 5.

Note that FIG. 1 is a schematic diagram showing the configuration of the NV level determination system 1 that is segmented based on main processing contents in order to facilitate the understanding of the invention of the present disclosure, and the NV level determination system 1 may be configured based on other segments. A process by each constituent element may be executed by one hardware unit, or may be executed by a plurality of hardware units. A process by each constituent element shown in FIG. 5 may be executed based on one program, or may be executed based on a plurality of programs.

### 5. Configurations Supported by the Embodiments

The above-described embodiments are specific examples of the following configurations.

(Configuration 1) An NV level determination system that determines a noise vibration (NV) level for an electric vehicle including a drive motor and a power transmission unit that transmits driving force of the drive motor to a wheel, the NV level being a level of noise or vibration occurring from the power transmission unit, the NV level determination system including: a rotor rotation angle recognition section that recognizes an angle of rotation of a rotor of the drive motor; a transmission error recognition section that recognizes a transmission error in the power transmission unit, based on a change degree of an amount of change in angle of rotation of the rotor with respect to an amount of change in angle of rotation of a driveshaft of the electric vehicle in a state where external force to rotate the driveshaft at a predetermined rotation speed is applied to the driveshaft; and an NV level determination section that determines the NV level, based on the transmission error recognized by the transmission error recognition section.

According to the NV level determination system in configuration 1, it is possible to recognize the transmission error in the power transmission unit and determine the NV level of the power transmission unit, with a simple configuration of recognizing the angle of rotation of the rotor of the drive motor rotated by the power transmission unit in a state where the driveshaft is rotated by applying external force from the driveshaft side of the electric vehicle.

(Configuration 2) The NV level determination system according to configuration 1, wherein the predetermined rotation speed is set within a rotation speed range including a rotation speed corresponding to a travel speed, in an assumed travel speed range of the electric vehicle, at which the NV level is assumed to become highest.

According to the NV level determination system in configuration 2, it is possible to determine the NV level under a condition corresponding to a travel situation in which noise or vibrations that are annoying to a user of the electric vehicle are likely to occur.

(Configuration 3) The NV level determination system according to configuration 2, wherein the predetermined rotation speed is set for each vehicle type of electric vehicle.

According to the NV level determination system in configuration 3, it is possible to appropriately set the predetermined rotation speed used in determining the NV level, according to the specification of a power transmission system, which varies with the vehicle type of electric vehicle.

(Configuration 4) An NV level determination method of determining a noise vibration (NV) level for an electric vehicle including a drive motor and a power transmission unit that transmits driving force of the drive motor to a wheel, the NV level being a level of noise or vibration occurring from the power transmission unit, the NV level determination method including: a rotor rotation angle recognition step of recognizing an angle of rotation of a rotor of the drive motor; a transmission error recognition step of recognizing a transmission error at a gear included in the power transmission unit, based on a change degree of an amount of change in angle of rotation of the rotor with respect to an amount of change in angle of rotation of a driveshaft of the electric vehicle in a state where external force to rotate the driveshaft at a predetermined rotation speed is applied to the driveshaft; and a gear NV level determination step of determining the NV level, based on the transmission error recognized in the transmission error recognition step.

By a computer executing the NV level determination method in configuration 4, it is possible to bring about operations and effects similar to those of the NV level determination system in configuration 1.

### REFERENCE SIGNS LIST

1 NV level determination system, 10 processor, 11 rotor rotation angle recognition section, 12 transmission error recognition section, 13 NV level determination section, 20 memory, 21 program, 22 transmission error-NV level correspondence map, 50 drive motor, 52 motor shaft, 52 resolver, 53 rotor, 60 power transmission unit, 62 differential, 70 tire-wheel assembly, 71 driveshaft, 100 electric vehicle, 200 measurement device, 210 roller, 211 roller motor, 300 communication network, 310 vehicle management system.

1. An NV level determination system that determines a noise vibration (NV) level for an electric vehicle including a drive motor and a power transmission unit that transmits driving force of the drive motor to a wheel, the NV level being a level of noise or vibration occurring from the power transmission unit, the NV level determination system comprising:
a rotor rotation angle recognition section that recognizes an angle of rotation of a rotor of the drive motor;
a transmission error recognition section that recognizes a transmission error in the power transmission unit, based on a change degree of an amount of change in angle of rotation of the rotor with respect to an amount of change in angle of rotation of a driveshaft of the electric vehicle in a state where external force to rotate the driveshaft at a predetermined rotation speed is applied to the driveshaft; and
an NV level determination section that determines the NV level, based on the transmission error recognized by the transmission error recognition section.

2. The NV level determination system according to claim 1, wherein the predetermined rotation speed is set within a rotation speed range including a rotation speed corresponding to a travel speed, in an assumed travel speed range of the electric vehicle, at which the NV level is assumed to become highest.

3. The NV level determination system according to claim 2, wherein the predetermined rotation speed is set for each vehicle type of electric vehicle.

4. An NV level determination method of determining a noise vibration (NV) level for an electric vehicle including a drive motor and a power transmission unit that transmits driving force of the drive motor to a wheel, the NV level being a level of noise or vibration occurring from the power transmission unit, the NV level determination method comprising:
a rotor rotation angle recognition step of recognizing an angle of rotation of a rotor of the drive motor;
a transmission error recognition step of recognizing a transmission error at a gear included in the power transmission unit, based on a change degree of an amount of change in angle of rotation of the rotor with respect to an amount of change in angle of rotation of a driveshaft of the electric vehicle in a state where external force to rotate the driveshaft at a predetermined rotation speed is applied to the driveshaft; and
a gear NV level determination step of determining the NV level, based on the transmission error recognized in the transmission error recognition step.
